(19) United States
(12) Patent Application Publication
(10) Pub. No.: US 2024/0339251 A1
(43) Pub. Date: Oct. 10, 2024

(54) NEODYMIUM-IRON-BORON MAGNET AND PREPARATION METHOD THEREFOR

(71) Applicant: Fujian Golden Dragon Rare-Earth Co., Ltd, Longyan (CN)

(72) Inventors: ZHIHUI TANG, Longyan (CN); JIAYING HUANG, Xiamen (CN); XING WEI, Longyan (CN); ZHIGANG LI, Longyan (CN); DEQIN XU, Longyan (CN); DAKUN CHEN, Longyan (CN)

(21) Appl. No.: 18/546,486

(22) PCT Filed: Jan. 17, 2022
(86) PCT No.: PCT/CN2022/072243

§ 371 Date: Dec. 21, 2023

(30) Foreign Application Priority Data
Mar. 10, 2021 (CN) 202110262716.9

(51) Int. Cl. H01F 1/057; B22F 3/16; B22F 3/24; B22F 9/02; B22F 9/04; C22C 33/06; C22C 38/00; C22C 38/06; C22C 38/10; C22C 38/14; C22C 38/16

(52) U.S. Cl. CPC H01F 1/057; B22F 3/16; B22F 3/24; B22F 9/023; B22F 9/04; C22C 33/06; C22C 38/002; C22C 38/005; C22C 38/06; C22C 38/10; C22C 38/14; C22C 38/16; B22F 2003/248; B22F 2009/044; B22F 2201/03; B22F 2202/05; B22F 2301/355; B22F 2998/10; B22F 2999/00; C22C 2202/02

(57) ABSTRACT

The invention discloses a neodymium-iron-boron magnet and a preparation method thereof. The neodymium-iron-boron magnet comprises a main phase crystal grain, a shell layer of the main phase crystal grain and a Nd-rich phase adjacent to the main phase crystal grain, wherein the main phase crystal grain comprises Nd₂Fe₁₄B; or the main phase crystal grain comprises Nd₂Fe₁₄B and Pr₂Fe₁₄B; the shell layer comprises (Nd/Dy)₂Fe₁₄B and/or (Nd/Tb)₂Fe₁₄B; the shell layer has a thickness of 0.1-6 μm; the Nd-rich phase comprises a R₆Fe₁₃B phase, wherein the R is one or more selected from the group consisting of Nd, Pr, Dy and Tb. The method of the invention effectively reduces the diffusion amount of the heavy rare earth elements into the main phase, forms a thinner heavy rare earth shell layer, and can further optimize and improve the high temperature performance of the magnet.

### FIELD OF THE INVENTION

The invention relates to a neodymium-iron-boron magnet and a preparation method thereof.

### BACKGROUND OF THE INVENTION

At present, there are many ways to optimize grain boundaries in the neodymium-iron-boron industry. For example, a single low-melting point element is added to the formulation to increase the fluidity. Alternatively, the content of heavy rare earth elements is increased to increase the magnetocrystalline anisotropy field, such as the double alloy method. This method includes adding a high proportion of Dy or Tb to prepare an auxiliary alloy, smelting the auxiliary alloy and the main alloy separately, and then mixing the two according to the performance of the product in the hydrogen decrepitation stage or jet milling stage. Although the magnetic properties of the prepared neodymium-iron-boron magnets are improved compared with those prepared in the single alloy processes, due to the sintering and aging process, most of the Dy\Tb will enter the main phase, which greatly reduces the utilization rate of heavy rare earths, resulting in a certain cost and waste of resources.

Patent document CN111636035A discloses a heavy rare earth alloy, a neodymium-iron-boron permanent magnet material, a raw material and a preparation method. By controlling the contents of Ti and/or Zr and the total amount of heavy rare earth elements or the like, Ti and/or Zr are combined with B, so as to avoid excessive heavy rare earth metals to be combined with B. At the same time, the high melting point compound thereof is a non-ferromagnetic phase, which can play a role of pinning and increasing magnetic isolation coupling at the grain boundary, hinder the formation of anti-magnetization domains, reduce the amount of heavy rare earth metals diffused into the main phase, and improve the performance of the magnet. But, this solution needs further optimization. The amount of heavy rare earths such as Dy and Tb diffused into the main phase is still quite large, and the thickness of the shell formed by these heavy rare earth elements on the outer edge of the main phase is relatively deep.

Therefore, further improvement is needed for the double alloy method, which can effectively make the more expensive heavy rare earth elements such as Dy and Tb to form a thinner shell around the main phase, so as to reduce the diffusion degree of heavy rare earth elements into the main phase.

### SUMMARY OF THE INVENTION

In order to solve the problem that a large amount of heavy rare earth elements diffuse into the main phase in the double alloy method in the prior art, the invention provides a neodymium-iron-boron magnet and a preparation method thereof. The method of the invention effectively reduces the diffusion amount of the heavy rare earth elements into the main phase, forms a thinner heavy rare earth shell layer, and can further optimize and improve the high temperature performance of the magnet.

The present invention solves the above-mentioned technical problem through the following technical solutions.

The invention provides a neodymium-iron-boron magnet, comprising a main phase crystal grain, a shell layer of the main phase crystal grain and a Nd-rich phase adjacent to the main phase crystal grain, wherein
the main phase crystal grain comprises Nd₂Fe₁₄B; or the main phase crystal grain comprises Nd₂Fe₁₄B and Pr₂Fe₁₄B;
the shell layer comprises (Nd/Dy)₂Fe₁₄B and/or (Nd/Tb)₂Fe₁₄B;
the shell layer has a thickness of 0.1-6 μm;
the Nd-rich phase comprises a R₆Fe₁₃B phase, wherein the R is one or more selected from the group consisting of Nd, Pr, Dy and Tb.

In the invention, preferably, the shell layer has a thickness of 0.1-5 μm, preferably 0.1-5 μm, more preferably 0.1-4 μm.

In the invention, preferably, the shell layer accounts for 30%-60% by volume, preferably 45-56% by volume, such as 45.7% by volume, 50.3% by volume, 50.78% by volume or 52.7% by volume of the neodymium-iron-boron magnet.

In the invention, preferably, the Nd-rich phase further comprises ZrB₂ and/or TiB₂.

In the invention, preferably, the Nd-rich phase further comprises a first grain boundary phase comprising Fe, T and B, wherein T is Zr and/or Ti.

In the invention, preferably, the Nd-rich phase further comprises a second grain boundary phase comprising Nd, Ga, Al, Fe and Dy.

The invention further provides a preparation method of the neodymium-iron-boron magnet as mentioned above, comprising the steps of:
S1: preparing a main alloy sheet and an auxiliary alloy sheet respectively;
wherein, the raw material for the main alloy sheet comprises LH₁, RH₁, X₁, Y₁, Fe and B; the LH₁ is Nd or a PrNd alloy; the RH₁ is one or more selected from the group consisting of Tb, Dy, Ho and Gd; the X₁ is one or more selected from the group consisting of Ti, Zr and Nb; and the Y₁ is one or more selected from the group consisting of Al, Cu, Ga and Co;
in the raw material for the main alloy sheet, the LH₁ accounts for 25-27.5% by mass of the main alloy sheet, the RH₁ accounts for 0-10% by mass of the main alloy sheet, the X₁ accounts for 0.05-0.6% by mass of the main alloy sheet, and the Y1 accounts for 0.05-3.5% by mass of the main alloy sheet, wherein the sum of the mass percentages of respective elements in the main alloy sheet is 100%;
the raw material for the auxiliary alloy sheet comprises RH₂, X₂ and Fe; the RH₂ is Tb and/or Dy, and the X₂ is one or more selected from the group consisting of Ti, Zr and Nb;
in raw material for the auxiliary alloy sheet, the RH₂ accounts for 10-85% by mass of the auxiliary alloy sheet, and the X₂ accounts for 0-8% by mass of the auxiliary alloy sheet, wherein the sum of the mass percentages of respective elements in the auxiliary alloy sheet is 100%;
S2: subjecting a mixture, which is obtained by hydrogen decrepitating or pulverizing the main alloy sheet and the auxiliary alloy sheet, to orientation pressing treatment, isostatic pressing treatment and sintering treatment to achieve the neodymium-iron-boron material, wherein
the mass of the main alloy sheet accounts for 82% or more and less than 100% of the total mass of the main alloy sheet and the auxiliary alloy sheet.

In S1, those skilled in the field know that, in the raw material for the main alloy sheet, the PrNd alloy refers to an alloy of Pr and Nd; preferably, Pr accounts for 0-34% by mass, excluding 0% by mass; preferably 0-7% by mass, excluding 0% by mass of the PrNd alloy.

In S1, preferably, in the raw material for the main alloy sheet, the LH₁ accounts for 25-27% by mass, such as 25.2% by mass or 26.58% by mass of the main alloy sheet.

In S1, preferably, in the raw material for the main alloy sheet, the RH₁ accounts for 0-5% by mass, excluding 0% by mass; preferably 3-5% by mass, such as 4% by mass, 4.2% by mass or 4.4% by mass of the main alloy sheet.

In S1, preferably, in the raw material for the main alloy sheet, the RH₁ is Dy and/or Gd.

Wherein, preferably, when the raw material for the main alloy sheet comprises Dy, the Dy accounts for 4-5% by mass, such as 4% by mass or 4.2% by mass of the main alloy sheet.

Wherein, preferably, when the raw material for the main alloy sheet comprises Gd, the Gd accounts for 0-1% by mass, such as 0.4% by mass of the main alloy sheet.

In S1, preferably, in the raw material for the main alloy sheet, the X₁ accounts for 0.1-0.3% by mass, for example 0.2% by mass of the main alloy sheet.

In S1, preferably, when the raw material for the main alloy sheet comprises Zr, the Zr accounts for 0-0.5% by mass, excluding 0% by mass; such as 0.1% by mass of the main alloy sheet.

In S1, preferably, when the raw material for the main alloy sheet comprises Ti, the Ti accounts for 0.05-0.3% by mass, such as 0.2% by mass of the main alloy sheet.

In S1, preferably, in the raw material for the main alloy sheet, the Y₁ accounts for 1.5-3.5% by mass, such as 1.96% by mass, 2.09% by mass or 3.1% by mass of the main alloy sheet.

In S1, preferably, when the raw material for the main alloy sheet comprises Co, the Co accounts for 1-3% by mass, preferably 1-2.5% by mass, such as 1.19% by mass or 2.2% by mass of the main alloy sheet.

In S1, preferably, when the raw material for the main alloy sheet comprises Cu, the Cu accounts for 0.1-0.5% by mass, preferably 0.2-0.3% by mass, for example 0.21% by mass or 0.3% by mass of the main alloy sheet.

In S1, preferably, when the raw material for the main alloy sheet comprises Al, the Al accounts for 0.05-0.7% by mass, preferably 0.2-0.45% by mass, such as 0.2% by mass, 0.3% by mass or 0.43% by mass of the main alloy sheet.

In S1, preferably, when the raw material for the main alloy sheet comprises Ga, the Ga accounts for 0.1-0.4% by mass, preferably 0.25-0.4% by mass, such as 0.26% by mass of the main alloy sheet.

In S1, preferably, when the raw material for the main alloy sheet comprises Cu and Ti, the mass ratio of Cu to Ti is (1-1.5):1.

In S1, preferably, when the raw material for the main alloy sheet comprises Ti, Cu and Al, the total amount of Ti, Cu and Al accounts for 0.05-2% by mass, preferably 0.3-1.25% by mass, more preferably 0.7-0.9% by mass, such as 0.71% by mass or 0.84% by mass of the main alloy sheet.

In S1, preferably, in the raw material for the main alloy sheet, the B accounts for 0.88-1.05% by mass, preferably 0.95-1% by mass, for example 0.98% by mass of the main alloy sheet.

In a preferably embodiment of S1, the main alloy sheet comprises: Nd with a content of 26.58%; Dy with a content of 4%; Co with a content of 1.19%; Cu with a content of 0.21%; Al with a content of 0.3%; Ga with a content of 0.26%; Ti with a content of 0.2%; B with a content of 1%; Fe with a content of 66.26%, wherein the percentages refer to the mass percentages of the components in the raw material for the main alloy sheet.

In a preferably embodiment of S1, the main alloy sheet comprises: Nd with a content of 26.58%; Dy with a content of 4%; Gd with a content of 0.4%; Co with a content of 2.2%; Cu with a content of 0.21%; Al with a content of 0.43%; Ga with a content of 0.26%; Ti with a content of 0.2%; B with a content of 1%; Fe with a content of 64.72%, wherein the percentages refer to the mass percentages of the components in the raw material for the main alloy sheet.

In a preferably embodiment of S1, the main alloy sheet comprises: Nd with a content of 25.2%; Dy with a content of 4.2%; Co with a content of 1.19%; Cu with a content of 0.3%; Al with a content of 0.2%; Ga with a content of 0.4%; Zr with a content of 0.1%; Ti with a content of 0.2%; B with a content of 0.98%; Fe with a content of 67.23%, wherein the percentages refer to the mass percentages of the components in the raw material for the main alloy sheet.

In a preferably embodiment of S1, the main alloy sheet comprises: the PrNd alloy with a content of 26.58%; Dy with a content of 4%; Co with a content of 1.19%; Cu with a content of 0.21%; Al with a content of 0.3%; Ga with a content of 0.26%; Ti with a content of 0.2%; B with a content of 1%; Fe with a content of 66.26%, wherein the percentages refer to the mass percentages of the components in the raw material for the main alloy sheet; and the mass ratio of Pr to Nd in the PrNd alloy is 25:75.

In S1, preferably, the main alloy sheet is obtained by smelting and casting the raw material for the main alloy sheet, and the operations and conditions for the smelting and casting can be conventional in the art.

Wherein, preferably, in the preparation method of the main alloy sheet, the temperature for smelting raw material for the main alloy sheet is 1500-1550° C.

Wherein, in the preparation method of the main alloy sheet, the temperature for the casting is preferably 1400-1450° C.

Wherein, in the preparation method of the main alloy sheet, the copper roll for the casting preferably has a rotational speed of 35-55 rmp/min.

Wherein, in the preparation method of the main alloy sheet, the copper roll for the casting has an inlet water temperature of preferably 30° C. or less.

Wherein, in the preparation method of the main alloy sheet, the copper roll for the casting has an outlet water temperature of preferably 55° C. or less.

In S1, preferably, in the raw material for the auxiliary alloy sheet, the RH₂ accounts for 35-85% by mass, preferably 40-60% by mass, for example 55% by mass of the auxiliary alloy sheet.

In S1, preferably, when the raw material for the auxiliary alloy sheet comprises Dy, the Dy accounts for 40-75% by mass, such as 55% by mass of the auxiliary alloy sheet.

In S1, preferably, when the raw material for the auxiliary alloy sheet comprises Zr, the Zr accounts for 0-8% by mass, such as 7.3% by mass of the auxiliary alloy sheet.

In S1, preferably, the raw material for the auxiliary alloy sheet further comprises Nd, and the Nd accounts for 0-15% by mass of the auxiliary alloy sheet.

In S1, preferably, the raw material for the auxiliary alloy sheet further comprises B, and the B accounts for 0-1.5% by mass, preferably 0-0.9% by mass, for example 0.4% by mass of the auxiliary alloy sheet.

In a preferable embodiment of S1, the auxiliary alloy sheet comprises: Dy with a content of 55%; Zr with a content of 7.3%; and Fe with a content of 37.7%, wherein the percentages refer to the mass percentages of the components in the raw material for the auxiliary alloy sheet.

In a preferable embodiment of S1, the auxiliary alloy sheet comprises: Nd with a content of 15%; Dy with a content of 40%; B with a content of 0.4%; and Fe with a content of 44.6%, wherein the percentages refer to the mass percentages of the components in the raw material for the auxiliary alloy sheet.

In S1, preferably, the auxiliary alloy sheet is obtained by smelting and casting the raw material for the auxiliary alloy sheet, and the operations and conditions for the smelting and casting can be traditional in the field.

Wherein, preferably, in the preparation method of the auxiliary alloy sheet, the temperature for smelting raw material for the auxiliary alloy sheet is 1500-1550° C.

Wherein, in the preparation method of the auxiliary alloy sheet, the temperature for the casting is preferably 1500-1550° C.

Wherein, in the preparation method of the auxiliary alloy sheet, the copper roll for the casting has a rotational speed of preferably 35-55 rmp/min.

Wherein, in the preparation method of the auxiliary alloy sheet, the copper roll for the casting has an inlet water temperature of preferably 30° C. or less.

Wherein, in the preparation method of the auxiliary alloy sheet, the copper roll for the casting has an outlet water temperature of preferably 55° C. or less.

In S2, preferably, the mass of the main alloy sheet accounts for 90% or more and less than 100%, preferably 94-95% of the total mass of the main alloy sheet and the auxiliary alloy sheet.

In S2, preferably, a mixture of the main alloy sheet and the auxiliary alloy sheet is subjected to hydrogen decrepitation, pulverization, orientation pressing treatment, isostatic pressing treatment and sintering treatment to achieve the neodymium-iron-boron material; or
the main alloy sheet and the auxiliary alloy sheet are subjected to hydrogen decrepitation and pulverization respectively, then the fine powders obtained after pulverizing the main alloy sheet and the auxiliary alloy sheet are mixed, and then the mixed fine powder is subjected to orientation pressing treatment, isostatic pressing treatment and sintering treatment to achieve the neodymium-iron-boron material.

In S2, the operations and conditions for the hydrogen decrepitation, the pulverization, the orientation pressing treatment, the isostatic pressing treatment and the sintering treatment can be traditional in the field.

Wherein, the dehydrogenation temperature for the hydrogen decrepitation is preferably 540-560° C.

Wherein, preferably, the process of the hydrogen decrepitation is terminated within not less than 10 minutes after the pressure drop is less than 0.04 MPa.

Wherein, preferably, the pulverization is preferably jet mill pulverization.

Wherein, preferably, the oxygen supplement for the jet mill pulverization is 0-70 ppm.

Wherein, preferably, the fine particles obtained by the pulverization have a diameter of 3.5-4.5 μm.

Wherein, preferably, the magnetizing current for the orientation pressing is controlled at 950 A-970 A, such as 960 A.

Wherein, preferably, the green compact obtained by the orientation pressing has a compact density of 3.7-4.3 g/cm³, such as 4.1 g/cm³.

Wherein, preferably, the temperature for the sintering treatment is 1025-1150° C., such as 1070-1080° C.

Wherein, preferably, the time for the sintering treatment is 4-10 hours, such as 8 hours.

Wherein, preferably, an aging treatment is performed after the sintering treatment.

Preferably, the aging treatment includes a primary aging and/or a secondary aging. The temperature for the primary aging is preferably 850-940° C., and the time for the primary aging is preferably 2-5 hours. The temperature for the secondary aging is preferably 420-640° C., and the time for the secondary aging is preferably 2-5 hours.

On the basis of conforming to common knowledge in the field, the above-mentioned preferred conditions can be combined arbitrarily to obtain the preferred examples of the present invention.

The reagents and raw materials used in the present invention are all commercially available.

The positive effect of the present invention is as follows.

In the present invention, by improving the raw materials of the main alloy sheet and the auxiliary alloy sheet and cooperating with various process conditions, the diffusion amount of heavy rare earth elements into the main phase is effectively reduced, a thinner heavy rare earth shell layer is formed, and it is possible to further optimize and improve the high temperature performance of the magnet. It avoids the diffuse distribution of heavy rare earth elements in the main phase and grain boundary in the traditional double alloy method, which results in excessive waste of heavy rare earth elements.

In a preferred embodiment of the present invention, the sintered sample can be directly subjected to the secondary aging treatment, and the high-temperature performance of the obtained product is not only better than that of the sintered sample, but also better than that of the sample which has been subjected to primary aging treatment directly after sintering, and also better than that of the sample which has been subjected to the primary aging and secondary aging treatment after sintering. The present invention provides improvement that it is possible to directly cancel the primary aging or secondary aging processes in the follow-up, thereby simplifying the process and greatly reducing the processing cost.

### BRIEF DESCRIPTION OF THE DRAWINGS

FIG. 1 shows the change of Hcj performance measured at 180° C. after the sample prepared in Example 3 have been treated at different secondary aging temperatures.

FIG. 2 shows the EPMA profile of Example 3.

### DETAILED DESCRIPTION OF THE INVENTION

The present invention is further illustrated below by means of examples, but the present invention is not limited to the scope of the examples. The experimental methods not indicating specific conditions in the following examples were carried out according to conventional methods and conditions, or were selected according to the product instructions.

### EXAMPLE 1

(1) According to the formulations shown in Table 1, the raw materials for the main alloy sheet and the auxiliary alloy sheet were smelted and casted respectively to prepare a main alloy sheet and an auxiliary alloy sheet.

Wherein, in the preparation of the main alloy sheet, the smelting temperature for the main alloy sheet was 1500-1550° C., the casting temperature for the casting was 1400-1450° C., the rotational speed of the copper roll for the casting was 35-55 rmp/min, the inlet water temperature of the copper roll for the casting was ≤30° C., and outlet water temperature of the copper roll for the casting was ≤55° C.;
in the preparation of the auxiliary alloy sheet, the smelting temperature for the auxiliary alloy sheet was 1500-1550° C., the casting temperature for the casting was 1500-1550° C., the rotational speed of the copper roll for the casting was 35-55 rmp/min, the inlet water temperature of the copper roll for the casting was ≤30° C., and outlet water temperature of the copper roll for the casting was ≤55° C.
(2) Hydrogen Decrepitation Process:

A mixture of the main alloy sheet and the auxiliary alloy sheet prepared in Step (1) was subjected to hydrogen decrepitation at 550° C. for 3 hours to obtain a coarse pulverized powder.
(3) Pulverization Treatment:

The coarse pulverized powder prepared in Step (2) was finely pulverized in a jet mill in an atmosphere with an oxygen supply of 0-70 ppm to obtain a finely pulverized powder with an average particle size of D50=3.5-4.5 μm.
(4) Orientation Pressing Process:

The magnetizing current was controlled at 960 A, and the compact density was 4.1 g/cm³.
(5) Isostatic Pressing Process.
(6) Sintering Process: the sample obtained in step (5) was sintered at a sintering temperature of 1070-1080° C. for 8 hours.

TABLE 1
The formula of raw materials in Examples 1-7

| | Raw | Examples | Example | Example | Example |
|---|---|---|---|---|---|
| | Materials | 1-4 | 5 | 6 | 7 |
| Main | Nd | 26.58 | 26.58 | 25.2 | / |
| Alloy | PrNd | / | / | / | 26.58 |
| | Dy | 4 | 4 | 4.2 | 4 |
| | Gd | / | 0.4 | / | / |
| | Co | 1.19 | 2.2 | 1.19 | 1.19 |
| | Cu | 0.21 | 0.21 | 0.3 | 0.21 |
| | Al | 0.3 | 0.43 | 0.2 | 0.3 |
| | Ga | 0.26 | 0.26 | 0.4 | 0.26 |
| | Zr | / | / | 0.1 | / |
| | Ti | 0.2 | 0.2 | 0.2 | 0.2 |
| | B | 1 | 1 | 0.98 | 1 |
| | Fe | 66.26 | 64.72 | 67.23 | 66.26 |
| Auxiliary | Nd | / | / | 15 | / |
| Alloy | Dy | 55 | 55 | 40 | 55 |
| | Zr | 7.3 | 7.3 | / | 7.3 |
| | B | / | / | 0.4 | / |
| | Fe | 37.7 | 37.7 | 44.6 | 37.7 |

| | | | | |
|---|---|---|---|---|
| Mass Ratio of Main | 96:4 | 96:4 | 95:5 | 96:4 |
| Alloy to Auxiliary | | | | |
| Alloy | | | | |

Wherein, “/” means that this component is not comprised; PrNd is a PrNd alloy with a mass ratio of 25:75.

### EXAMPLE 2

Example 2 was performed according to the formula shown in Table 1, wherein Steps (1)-(6) were the same as Steps (1)-(6) of Example 1. The sample obtained in Step (6) was subjected to a primary aging including heat treatment at 900° C. for 3 hours.

### EXAMPLE 3

Example 3 was performed according to the formula shown in Table 1, wherein Steps (1)-(6) were the same as Steps (1)-(6) of Example 1. The sample obtained in Step (6) was subjected to a secondary aging including heat treatment at 600° C. for 3 hours.

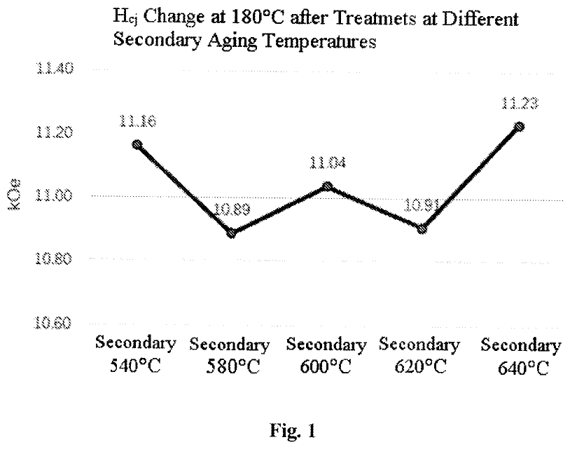

Furthermore, as shown in FIG. 1, verification experiments were carried out for different secondary aging temperatures. It was found that when the secondary temperature changed from 540° C. to 640° C., the Hcj of the sample at 180° C. was still in a relatively stable performance state. This indicated that the temperature sensitivity of the sample to the secondary aging is lower, which is conducive to stable mass production and can avoid the interference of temperature on the performance of the product.

### EXAMPLE 4

Example 4 was performed according to the formula shown in Table 1, wherein Steps (1)-(6) were the same as Steps (1)-(6) of Example 1. The sample obtained in Step (6) was subjected to a primary aging including heat treatment at 900° C. for 3 hours and a secondary aging including heat treatment at 600° C. for 3 hours.

### EXAMPLE 5

Example 5 was performed according to the formula shown in Table 1, wherein Steps (1)-(6) were the same as Steps (1)-(6) of Example 1.

### EXAMPLE 6

Example 6 was performed according to the formula shown in Table 1, wherein Steps (1)-(6) were the same as Steps (1)-(6) of Example 1.

### EXAMPLE 7

Example 7 was performed according to the formula shown in Table 1, wherein Steps (1)-(6) were the same as Steps (1)-(6) of Example 1.

### COMPARATIVE EXAMPLE 1

(1) According to the formulations shown in Table 2, the raw material for a main alloy sheet was smelted and casted to prepare a main alloy sheet.

Wherein, in the preparation of the main alloy sheet, the smelting temperature for the main alloy sheet was 1500-1550° C., the casting temperature for the casting was 1400-1450° C., the rotational speed of the copper roll for the casting was 50 rmp/min, the inlet water temperature of the copper roll for the casting was ≤30° C., and outlet water temperature of the copper roll for the casting was ≤55° C.
(2) Hydrogen Decrepitation Process:

At room temperature, the main alloy sheet prepared in Step (1) was subjected to hydrogen decrepitation treatment at 550° C. for 3 hours to obtain a coarse pulverized powder.
(3) Pulverization Treatment:

The coarse pulverized powder prepared in Step (2) was finely pulverized in a jet mill in an atmosphere with an oxygen supply of 0)-70 ppm to obtain a finely pulverized powder with an average particle size of D50=3.5-4.5 μm.
(4) Orientation Pressing Process:

The magnetizing current was controlled at 960 A, and the compact density was 4.1 g/cm³.
(5) Isostatic Pressing Process.
(6) Sintering Process: The sample obtained in step (5) was sintered in an inert gas atmosphere at a sintering temperature of 1025-1150° C. for 8 hours.
(7) The sample obtained in Step (6) was subjected to a primary aging including heat treatment at 900° C. for 3 hours and a secondary aging including heat treatment at 600° C. for 3 hours.

### COMPARATIVE EXAMPLE 2

According to the formulations shown in Table 2, in the preparation of the auxiliary alloy sheet, the smelting temperature for the auxiliary alloy sheet was 1380-1420° C., the casting temperature for the casting was 1340-1360° C., the rotational speed of the copper roll was 26.8-27.2 rmp/min, the inlet water temperature of the copper roll for the casting was ≤30° C., and outlet water temperature of the copper roll for the casting was ≤55° C.

The sintering temperature of the sintering process was 1060-1070° C. The primary aging included heat treatment at 895-905° C. for 3 hours, and the secondary aging included heat treatment at 485-495° C. for 3 hours.

All of other processing parameters were the same as those in Comparative Example 1.

### COMPARATIVE EXAMPLE 3

Comparative Example 3 was performed according to the formula shown in Table 2, wherein Steps (1)-(7) were the same as Steps (1)-(7) of Comparative Example 2.

TABLE 2
The formula of raw materials in Comparative Examples 1-3

| | Raw | Comparative | Comparative | Comparative |
|---|---|---|---|---|
| | Materials | Example 1 | Example 2 | Example 3 |
| Main | PrNd | 24 | 24 | 25 |
| Alloy | Dy | 7.5 | 4.9 | 3.7 |
| | Gd | / | 1.2 | 1.6 |
| | Co | 1 | 1 | 1 |
| | Cu | 0.2 | 0.2 | 0.2 |
| | Al | 0.1 | 0.1 | 0.1 |
| | Ga | 0.3 | 0.3 | 0.3 |
| | Nb | 0.3 | 0.2 | / |
| | Zr | / | / | 0.2 |
| | B | 0.95 | 0.95 | 0.95 |
| | Fe | 65.65 | 67.15 | 66.95 |
| Auxiliary | Nd | / | 9.7 | 9.7 |
| Alloy | Pr | / | 3.3 | 3.3 |
| | Dy | / | 30 | 30 |
| | Nb | / | 0.2 | 0.2 |
| | B | / | 0.95 | 0.95 |
| | Co | / | 1 | 1 |
| | Cu | / | 0.2 | 0.2 |
| | Al | / | 0.2 | 0.2 |
| | Fe | / | 54.45 | 54.45 |

| | | | |
|---|---|---|---|
| Mass Ratio of Main | / | 90:10 | 90:10 |
| Alloy to Auxiliary | | | |
| Alloy | | | |

Wherein, “/” means that this component is not comprised; PrNd is a PrNd alloy with a mass ratio of 25:75.

### EFFECT EXAMPLES

Test for magnetic properties: The magnetic properties of the neodymium-iron-boron magnets were tested by using the PFM14.CN molding type ultra-high coercivity permanent magnet measuring instrument of China Metrology Institute. The results measured in respective Examples and Comparative Examples are shown in Tables 3-5.

TABLE 3
The comparison of microstructural parameters and magnetic performance
among Examples 3, 5-7 and Comparative examples 1-3

| | | | | | Comparative | Comparative | Comparative |
|---|---|---|---|---|---|---|---|
| | Example 3 | Example 5 | Example 6 | Example 7 | Example 1 | Example 2 | Example 3 |
| Whether shell | Yes | Yes | Yes | Yes | No | No | No |
| structure is | | | | | | | |
| formed | | | | | | | |
| Whether | Yes | Yes | Yes | Yes | No | No | No |
| R₆Fe₁₃B | | | | | | | |
| phase is | | | | | | | |
| formed | | | | | | | |
| Volume Ratio | 45.7% | 50.3% | 52.7% | 50.78% | No | No | No |
| of Shell | | | | | | | |
| Layer | | | | | | | |
| Thickness of | 0.1-4 μm | 0.1-5 μm | 0.1-6 μm | 0.1-6 μm | No | No | No |
| Sheel layer | | | | | | | |
| 20° C., Br | 12.19 | 12.05 | 12.25 | 12.04 | 12.05 | 12.08 | 12 |
| 20° C., H_{cj} | 33.21 | 32.39 | 32.2 | 32.18 | 32.65 | 32.59 | 32.49 |
| 180° C., Br | 10.08 | 9.98 | 10.10 | 9.99 | 10.05 | 9.95 | 9.9 |
| 180° C., H_{cj} | 11.48 | 11.28 | 10.84 | 10.90 | 10.74 | 10.73 | 10.40 |
| Squareness | 0.971 | 0.977 | 0.977 | 0.988 | 0.968 | 0.960 | 0.964 |

It can be seen from Table 3 that the present invention can effectively reduce the diffusion of heavy rare earth elements into the main phase, so that the heavy rare earth elements formed a thinner shell layer around the main phase, and the obtained neodymium-iron-boron magnets have excellent high temperature performance.

In Example 7, due to the addition of Pr element, it can help to improve the coercivity at room temperature, but in a high temperature environment, the thermal stability is not as good as that of the sample with only Nd element in light rare earth elements was added.

TABLE 4
The comparison of Magnetic Properties of Comparative
Examples 1-3 and Examples 1-4 at 20° C.

| | Br | H_{cb} | H_{cj} | (BH)max | |
|---|---|---|---|---|---|
| Samples | (kGs) | (kOe) | (kOe) | (MGOe) | Hₖ/H_{cj} |
| Comparative Example 1 | 12.05 | 11.69 | 32.65 | 35.14 | 98.95 |
| Comparative Example 2 | 12.08 | 11.73 | 32.59 | 35.31 | 98.95 |
| Comparative Example 3 | 12.00 | 11.69 | 32.49 | 35.12 | 98.95 |
| Example 1 | 12.25 | 11.92 | 32.21 | 36.29 | 99.00 |
| Example 2 | 12.22 | 11.90 | 31.12 | 36.11 | 98.70 |
| Example 3 | 12.19 | 11.90 | 33.21 | 36.29 | 99.00 |
| Example 4 | 12.20 | 11.89 | 32.48 | 36.09 | 98.20 |

TABLE 5
The comparison of Magnetic Properties of Comparative
Examples 1-3 and Examples 1-4 at 180° C.

| | Br | H_{cb} | H_{cj} | (BH)max | | α(Br) | β(H_{cj}) |
|---|---|---|---|---|---|---|---|
| Samples | (kGs) | (kOe) | (kOe) | (MGOe) | Hₖ/H_{cj} | % | % |
| Comparative Example 1 | 10.05 | 9.23 | 10.74 | 23.79 | 96.84 | −0.104 | −0.419 |
| Comparative Example 2 | 9.95 | 9.14 | 10.73 | 23.35 | 96.04 | −0.110 | −0.419 |
| Comparative Example 3 | 9.90 | 9.02 | 10.40 | 23.05 | 96.45 | −0.109 | −0.425 |
| Example 1 | 10.09 | 9.30 | 11.1 | 24.12 | 95.30 | −0.110 | −0.410 |
| Example 2 | 10.11 | 8.65 | 9.64 | 24.09 | 95.90 | −0.108 | −0.431 |
| Example 3 | 10.08 | 9.32 | 11.48 | 23.72 | 96.52 | −0.108 | −0.409 |
| Example 4 | 10.09 | 9.31 | 10.9 | 24.17 | 97.90 | −0.108 | −0.415 |

By comparing the data in Table 4-5, it is found that compared with the traditional process (such as Comparative Example 3-5), the present invention can directly carry out the secondary aging process while saving 0.9-1.5% by mass of heavy rare earth elements. The normal temperature performance is similar, and the H_{cj} and β(H_{cj}) at a high temperature of 180° C. are significantly better than the traditional process, and thus have excellent high temperature characteristics.

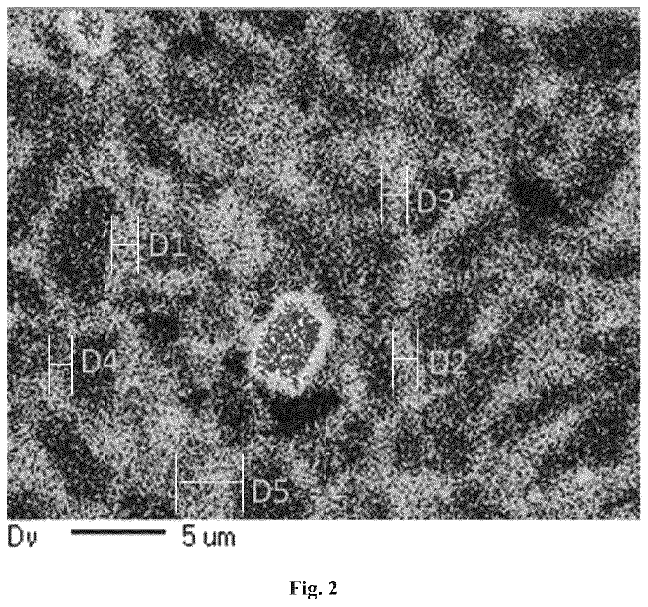

As shown in FIG. 2 and Table 6, they show the results of the EPMA diagram and the thickness of the heavy rare earth shell layer of the samples prepared in Example 3.

TABLE 6
The thickness of the heavy rare earth shell
layer of the samples prepared in Example 3.

| Samples | Thickness (μm) |
|---|---|
| D1 | 1.266 |
| D2 | 0.636 |
| D3 | 1.204 |
| D4 | 0.636 |
| D5 | 2.341 |

Although the specific implementation of the present invention has been described above, those skilled in the art should understand that this is only an example, and the protection scope of the present invention is defined by the appended claims. Those skilled in the art can make various changes or modifications to these embodiments without departing from the principle and essence of the present invention, and these changes and modifications all fall within the protection scope of the present invention.

What is claimed is:

1. A neodymium-iron-boron magnet. characterized by comprising a main phase crystal grain, a shell layer of the main phase crystal grain and a Nd-rich phase adjacent to the main phase crystal grain, wherein
the main phase crystal grain comprises Nd₂Fe₁₄B; or the main phase crystal grain comprises Nd₂Fe₁₄B and Pr₂Fe₁₄B;
the shell layer comprises (Nd/Dy)₂Fe₁₄B and/or (Nd/Tb)₂Fe₁₄B;
the shell layer has a thickness of 0.1-6 μm;
the Nd-rich phase comprises a R₆Fe₁₃B phase, wherein the R is one or more selected from the group consisting of Nd, Pr, Dy and Tb.

2. The neodymium-iron-boron magnet according to claim 1, characterized in that:
the shell layer has a thickness of 0.1-5 μm, preferably 0.1-5 μm, more preferably 0.1-4 μm; and/or
the shell layer accounts for 30%-60% by volume, preferably 45-56% by volume. such as 45.7% by volume, 50.3% by volume, 50.78% by volume or 52.7% by volume of the neodymium-iron-boron magnet; and/or
the Nd-rich phase further comprises ZrB₂ and/or TiB₂; and/or
the Nd-rich phase further comprises a first grain boundary phase comprising Fe, T and B, wherein Tis Zr and/or Ti; and/or
the Nd-rich phase further comprises a second grain boundary phase comprising Nd, Ga, Al, Fe and Dy.

3. A preparation method of the neodymium-iron-boron magnet according to claim 1 or 2, characterized by comprising the steps of:
S1: preparing a main alloy sheet and an auxiliary alloy sheet respectively;
wherein, the raw material for the main alloy sheet comprises LH₁, RH₁, X₁, Y₁, Fe and B; the LH₁ is Nd or a PrNd alloy; the RH₁ is one or more selected from the group consisting of Tb, Dy, Ho and Gd; the X₁ is one or more selected from the group consisting of Ti, Zr and Nb; and the Y₁ is one or more selected from the group consisting of Al, Cu, Ga and Co;
in the raw material for the main alloy sheet, the LH₁ accounts for 25-27.5% by mass of the main alloy sheet, the RH₁ accounts for 0-10% by mass of the main alloy sheet, the X₁ accounts for 0.05-0.6% by mass of the main alloy sheet, and the Y1 accounts for 0.05-3.5% by mass of the main alloy sheet, wherein the sum of the mass percentages of respective elements in the main alloy sheet is 100%;
the raw material for the auxiliary alloy sheet comprises RH₂, X₂ and Fe; the RH₂ is Tb and/or Dy, and the X₂ is one or more selected from the group consisting of Ti, Zr and Nb;
in raw material for the auxiliary alloy sheet, the RH₂ accounts for 10-85% by mass of the auxiliary alloy sheet, and the X₂ accounts for 0-8% by mass of the auxiliary alloy sheet, wherein the sum of the mass percentages of respective elements in the auxiliary alloy sheet is 100%;
S2: subjecting a mixture, which is obtained by hydrogen decrepitating or pulverizing the main alloy sheet and the auxiliary alloy sheet, to orientation pressing treatment, isostatic pressing treatment and sintering treatment to achieve the neodymium-iron-boron material, wherein
the mass of the main alloy sheet accounts for 82% or more and less than 100% of the total mass of the main alloy sheet and the auxiliary alloy sheet.

4. The preparation method of the neodymium-iron-boron magnet according to claim 3, characterized in that:
in S1, in the raw material for the main alloy sheet, Pr accounts for 0-34% by mass, excluding 0% by mass; preferably 0-7% by mass, excluding 0% by mass of the PrNd alloy; and/or
in S1, in the raw material for the main alloy sheet, the LH₁ accounts for 25-27% by mass, such as 25.2% by mass or 26.58% by mass of the main alloy sheet; and/or
in S1, in the raw material for the main alloy sheet, the RH₁ accounts for 0-5% by mass, excluding 0% by mass; preferably 3-5% by mass, such as 4% by mass, 4.2% by mass or 4.4% by mass of the main alloy sheet; and/or
in S1, in the raw material for the main alloy sheet, the RH₁ is Dy and/or Gd; and/or
in S1, when the raw material for the main alloy sheet comprises Dy, the Dy accounts for 4-5% by mass, such as 4% by mass or 4.2% by mass of the main alloy sheet; and/or
in S1, when the raw material for the main alloy sheet comprises Gd, the Gd accounts for 0-1% by mass, such as 0.4% by mass of the main alloy sheet; and/or
in S1, in the raw material for the main alloy sheet, the X₁ accounts for 0.1-0.3% by mass, for example 0.2% by mass of the main alloy sheet; and/or
in S1, when the raw material for the main alloy sheet comprises Zr, the Zr accounts for 0-0.5% by mass, excluding 0% by mass; such as 0.1% by mass of the main alloy sheet; and/or
in S1, when the raw material for the main alloy sheet comprises Ti, the Ti accounts for 0.05-0.3% by mass, such as 0.2% by mass of the main alloy sheet; and/or
in S1, in the raw material for the main alloy sheet, the Y₁ accounts for 1.5-3.5% by mass, such as 1.96% by mass, 2.09% by mass or 3.1% by mass of the main alloy sheet; and/or
in S1, when the raw material for the main alloy sheet comprises Co, the Co accounts for 1-3% by mass, preferably 1-2.5% by mass, such as 1.19% by mass or 2.2% by mass of the main alloy sheet; and/or
in S1, when the raw material for the main alloy sheet comprises Cu, the Cu accounts for 0.1-0.5% by mass, preferably 0.2-0.3% by mass, for example 0.21% by mass or 0.3% by mass of the main alloy sheet; and/or
in S1, when the raw material for the main alloy sheet comprises Al, the Al accounts for 0.05-0.7% by mass, preferably 0.2-0.45% by mass, such as 0.2% by mass, 0.3% by mass or 0.43% by mass of the main alloy sheet; and/or
in S1, when the raw material for the main alloy sheet comprises Ga, the Ga accounts for 0.1-0.4% by mass, preferably 0.25-0.4% by mass, such as 0.26% by mass of the main alloy sheet; and/or
in S1, when the raw material for the main alloy sheet comprises Cu and Ti, the mass ratio of Cu to Ti is (1-1.5):1; and/or
in S1, when the raw material for the main alloy sheet comprises Ti, Cu and Al, the total amount of Ti, Cu and Al accounts for 0.05-2% by mass, preferably 0.3-1.25% by mass, more preferably 0.7-0.9% by mass, such as 0.71% by mass or 0.84% by mass of the main alloy sheet; and/or
in S1, in the raw material for the main alloy sheet, the B accounts for 0.88-1.05% by mass, preferably 0.95-1% by mass, for example 0.98% by mass of the main alloy sheet.

5. The preparation method of the neodymium-iron-boron magnet according to claim 4, characterized in that:
the main alloy sheet comprises: Nd with a content of 26.58%; Dy with a content of 4%; Co with a content of 1.19%; Cu with a content of 0.21%; Al with a content of 0.3%; Ga with a content of 0.26%; Ti with a content of 0.2%; B with a content of 1%; Fe with a content of 66.26%, wherein the percentages refer to the mass percentages of the components in the raw material for the main alloy sheet; or
the main alloy sheet comprises: Nd with a content of 26.58%; Dy with a content of 4%; Gd with a content of 0.4%; Co with a content of 2.2%; Cu with a content of 0.21%; Al with a content of 0.43%; Ga with a content of 0.26%; Ti with a content of 0.2%; B with a content of 1%; Fe with a content of 64.72%, wherein the percentages refer to the mass percentages of the components in the raw material for the main alloy sheet; or
the main alloy sheet comprises: Nd with a content of 25.2%; Dy with a content of 4.2%; Co with a content of 1.19%; Cu with a content of 0.3%; Al with a content of 0.2%; Ga with a content of 0.4%; Zr with a content of 0.1%; Ti with a content of 0.2%; B with a content of 0.98%; Fe with a content of 67.23%, wherein the percentages refer to the mass percentages of the components in the raw material for the main alloy sheet; or
the main alloy sheet comprises: the PrNd alloy with a content of 26.58%; Dy with a content of 4%; Co with a content of 1.19%; Cu with a content of 0.21%; Al with a content of 0.3%; Ga with a content of 0.26%; Ti with a content of 0.2%; B with a content of 1%; Fe with a content of 66.26%, wherein the percentages refer to the mass percentages of the components in the raw material for the main alloy sheet; and the mass ratio of Pr to Nd in the PrNd alloy is 25:75

6. The preparation method of the neodymium-iron-boron magnet according to claim 3, characterized in that:
in S1, in the raw material for the auxiliary alloy sheet, the RH₂ accounts for 35-85% by mass, preferably 40-60% by mass, for example 55% by mass of the auxiliary alloy sheet; and/or
in S1, when the raw material for the auxiliary alloy sheet comprises Dy, the Dy accounts for 40-75% by mass, such as 55% by mass of the auxiliary alloy sheet; and/or
in S1, when the raw material for the auxiliary alloy sheet comprises Zr, the Zr accounts for 0-8% by mass, such as 7.3% by mass of the auxiliary alloy sheet; and/or
in S1, the raw material for the auxiliary alloy sheet further comprises Nd, and the Nd accounts for 0-15% by mass of the auxiliary alloy sheet; and/or
in S1, the raw material for the auxiliary alloy sheet further comprises B, and the B accounts for 0-1.5% by mass, preferably 0-0.9% by mass, for example 0.4% by mass of the auxiliary alloy sheet.

7. The preparation method of the neodymium-iron-boron magnet according to claim 6, characterized in that:
the auxiliary alloy sheet comprises: Dy with a content of 55%; Zr with a content of 7.3%; and Fe with a content of 37.7%, wherein the percentages refer to the mass percentages of the components in the raw material for the auxiliary alloy sheet; or
the auxiliary alloy sheet comprises: Nd with a content of 15%; Dy with a content of 40%; B with a content of 0.4%; and Fe with a content of 44.6%, wherein the percentages refer to the mass percentages of the components in the raw material for the auxiliary alloy sheet.

8. The preparation method of the neodymium-iron-boron magnet according to claim 3, characterized in that:
in S1, the main alloy sheet is obtained by smelting and casting the raw material for the main alloy sheet; or, the auxiliary alloy sheet is obtained by smelting and casting the raw material for the auxiliary alloy sheet; and/or
in the preparation method of the main alloy sheet, the temperature for smelting raw material for the main alloy sheet is 1500-1550° C.; and/or
in the preparation method of the main alloy sheet, the temperature for the casting is 1400-1450° C.; and/or
in the preparation method of the main alloy sheet, the copper roll for the casting has a rotational speed of 35-55 rmp/min; and/or
in the preparation method of the main alloy sheet, the copper roll for the casting has an inlet water temperature of 30° C. or less; and/or
in the preparation method of the main alloy sheet. the copper roll for the casting has an outlet water temperature of 55° C. or less; and/or
in the preparation method of the auxiliary alloy sheet. the temperature for smelting raw material for the auxiliary alloy sheet is 1500-1550° C.; and/or
in the preparation method of the auxiliary alloy sheet, the temperature for the casting is 1500-1550° C.; and/or
in the preparation method of the auxiliary alloy sheet, the copper roll for the casting has a rotational speed of 35-55 rmp/min; and/or
in the preparation method of the auxiliary alloy sheet, the copper roll for the casting has an inlet water temperature of 30° C. or less; and/or
in the preparation method of the auxiliary alloy sheet, the copper roll for the casting has an outlet water temperature of 55° C. or less.

9. The preparation method of the neodymium-iron-boron magnet according to claim 3, characterized in that:
the mass of the main alloy sheet accounts for 90% or more and less than 100%, preferably 94-95% of the total mass of the main alloy sheet and the auxiliary alloy sheet; and/or
in S2, a mixture of the main alloy sheet and the auxiliary alloy sheet is subjected to hydrogen decrepitation, pulverization, orientation pressing treatment, isostatic pressing treatment and sintering treatment to achieve the neodymium-iron-boron material; or, the main alloy sheet and the auxiliary alloy sheet are subjected to hydrogen decrepitation and pulverization respectively, then the fine powders obtained after pulverizing the main alloy sheet and the auxiliary alloy sheet are mixed, and then the mixed fine powder is subjected to orientation pressing treatment, isostatic pressing treatment and sintering treatment to achieve the neodymium-iron-boron material.

10. The preparation method of the neodymium-iron-boron magnet according to claim 9, characterized in that:
the dehydrogenation temperature for the hydrogen decrepitation is 540-560° C.; and/or
the process of the hydrogen decrepitation is terminated within not less than 10 minutes after the pressure drop is less than 0.04 MPa;
the pulverization is jet mill pulverization; preferably, the oxygen supplement for the jet mill pulverization is 0-70 ppm; and/or
the fine particles obtained by the pulverization have a diameter of 3.5-4.5 μm; and/or
the magnetizing current for the orientation pressing is controlled at 950 A-970 A, such as 960 A; and/or
the green compact obtained by the orientation pressing has a compact density of 3.7-4.3 g/cm³, such as 4.1 g/cm³; and/or
the temperature for the sintering treatment is 1025-1150° C., such as 1070-1080° C.; and/or
the time for the sintering treatment is 4-10 hours, such as 8 hours; and/or
an aging treatment is performed after the sintering treatment; preferably, the aging treatment includes a primary aging and/or a secondary aging; the temperature for the primary aging is preferably 850-940° C., and the time for the primary aging is preferably 2-5 hours; and the temperature for the secondary aging is preferably 420-640° C., and the time for the secondary aging is preferably 2-5 hours.
